(19) United States
(12) Patent Application Publication
(10) Pub. No.: US 2015/0311929 A1
(43) Pub. Date: Oct. 29, 2015

(54) INTERFERENCE CANCELLATION USING INTERFERENCE MAGNITUDE AND PHASE COMPONENTS

(71) Applicant: QUALCOMM Incorporated, San Diego, CA (US)

(72) Inventors: Nicholas Michael Carbone, San Diego, CA (US); Roberto Rimini, San Diego, CA (US); Jibing Wang, San Diego, CA (US)

(73) Assignee: QUALCOMM Incorporated, San Diego, CA (US)

(21) Appl. No.: 14/261,280

(22) Filed: Apr. 24, 2014

(51) Int. Cl. H04B 1/10; H04B 1/44; H04B 15/00

(52) U.S. Cl. CPC H04B 1/1027; H04B 15/00; H04B 1/44

(57) ABSTRACT

A communication device can independently determine an interference magnitude component and an interference phase component for interference cancellation. The interference magnitude component may be estimated based, at least in part, on a magnitude polynomial expansion and a transmit signal of the communication device. The interference phase component may be estimated based, at least in part, on a phase polynomial expansion and the transmit signal. The magnitude polynomial expansion and the phase polynomial expansion may have different polynomial terms. The interference signal may be determined based, at least in part, on the interference magnitude component and the interference phase component. At least a portion of the interference signal may be cancelled from a receive signal received by the communication device.

### BACKGROUND

Embodiments of this disclosure generally relate to the field of communication networks and, more particularly, to interference cancellation in a communication device.

Wireless communication systems are widely deployed to provide various types of content such as voice, data, and so on. It is common to integrate multiple radios into a single communication device. A communication device may include one or more communication units. Self-jamming interference refers to interference of a receive signal that is received at a victim receiver of a communication device. Self-jamming interference may be associated with leakage of a transmit signal that is transmitted by an aggressor transmitter of the same communication device. The interference associated with the receive signal attributable to the transmit signal may degrade the performance of the communication device. Non-linear interference cancellation (NLIC) refers to the removal of at least part of the self-jamming interference from the receive signal.

### SUMMARY

Various embodiments for interference cancellation using an independent interference magnitude component and interference phase component are described. In one embodiment, an interference magnitude component is estimated based, at least in part, on a magnitude polynomial expansion and a transmit signal of a communication device. An interference phase component is estimated based, at least in part, on a phase polynomial expansion and the transmit signal, wherein the magnitude polynomial expansion and the phase polynomial expansion have different polynomial terms. An interference signal is determined based, at least in part, on the interference magnitude component and the interference phase component. At least a portion of the interference signal is cancelled from a receive signal received by the communication device.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating an example mechanism for interference cancellation using polar expressions;

FIG. 2 is an example block diagram illustrating one embodiment of interference cancellation using an independent interference magnitude component and interference phase component;

FIG. 3 is a flow diagram illustrating example operations of one embodiment for interference cancellation using polar expressions;

FIG. 4 is a flow diagram illustrating example operations of another embodiment for interference cancellation using an independent interference magnitude component and interference phase component; and

FIG. 5 is a block diagram of one embodiment of an electronic device including a mechanism for minimizing interference using polar expressions.

### DESCRIPTION OF EMBODIMENT(S)

The description that follows includes exemplary systems, methods, techniques, instruction sequences, and computer program products that embody techniques of the present disclosure. However, it is understood that the described embodiments may be practiced without these specific details. For instance, although examples describe interference cancellation operations when the transmitter and the receiver of a communication device implement a common communication protocol, embodiments are not so limited. In other embodiments, the interference cancellation operations may be executed when the transmitter and the receiver implement different communication protocols (e.g., a wide area network (WAN) communication protocol and a local area network (LAN) communication protocol). In other instances, well-known instruction instances, protocols, structures, and techniques have not been shown in detail in order not to obfuscate the description.

A communication device may implement full-duplex communication. In addition, two independent communication protocols may be active simultaneously on a communication device. In such a communication device, a transmit signal may leak into a receive communication band causing interference with received signals and degrading demodulation performance. Because of non-linear components in the transmitter and/or the receiver, the interference observed at the receiver is typically a distorted (non-linear) byproduct of the original transmit signal. For example, amplifying the transmit signal using a power amplifier may yield harmonics of the transmit signal in addition to the original transmit signal. In this example, the harmonics of the transmit signal may cause interference at the receiver. Non-linear interference cancellation (NLIC) is a technique in which an interference signal is reconstructed using the transmit signal and non-linearities. The interference signal is then removed from a receive signal received at the receiver.

Typically, NLIC is performed using a complex polynomial expansion that uses the transmit signal. The complex polynomial expansion may include both the magnitude and phase components of the interference signal. However, when the interference signal is represented in a Cartesian format, the magnitude and phase components are represented by a single complex polynomial having the same number of polynomial terms for the magnitude component and the phase component. This makes it difficult to independently determine the magnitude and phase components of the interference signal for interference cancellation.

A communication device can use polar expressions for non-linear interference cancellation. The transmit signal can be converted from complex coordinates (e.g., Cartesian format) to polar coordinates (e.g., magnitude/phase format) to yield an independent magnitude component and phase component of the transmit signal. By using polar expressions, separate polynomial expansions can be used to independently model each of the magnitude component and the phase component of the interference signal.

A magnitude component of the interference signal may be estimated based, at least in part, on a magnitude polynomial expansion and the magnitude component of the transmit signal. The phase component of the interference signal may be estimated based, at least in part, on a phase polynomial expansion and the phase component of the transmit signal. In accordance with this disclosure, an interference signal may be determined using the magnitude component of the interference signal and the phase component of the interference signal. The interference signal may be combined with a receive signal to minimize or cancel the interference caused by the transmitter at the receiver.

In one embodiment, a magnitude error may be determined based, at least in part, on a magnitude component of the receive signal and the magnitude component of the interference signal. The magnitude error may be used to refine coefficients of the magnitude polynomial expansion. A phase error may be determined based, at least in part, on a phase component of the receive signal and the phase component of the interference signal. The phase error may be used to refine coefficients of the phase polynomial expansion. Because the magnitude component and phase component of the interference signal are modeled separately using different polynomial expansions, they may be modeled using different polynomial terms with different exponents and/or using different polynomial degrees. Using an independent interference magnitude component and interference phase component for interference cancellation can provide additional degrees of freedom to estimate the magnitude component and the phase component of the interference signal. This, in turn, can provide better interference cancellation.

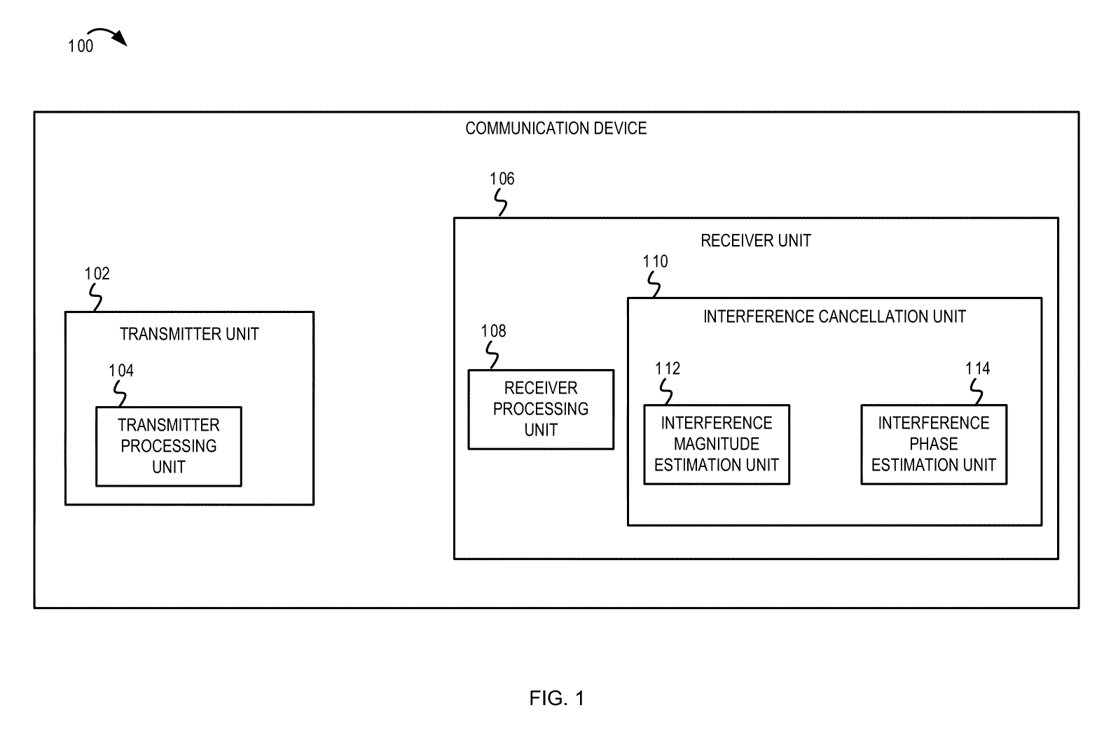

FIG. 1 is a block diagram illustrating an example mechanism for interference cancellation in accordance with this disclosure. FIG. 1 depicts a communication device 100 including a transmitter unit 102 and a receiver unit 106. The transmitter unit 102 includes transmitter processing unit 104. The receiver unit 106 includes a receiver processing unit 108 and an interference cancellation unit 110. The interference cancellation unit 110 includes an interference magnitude estimation unit 112, and an interference phase estimation unit 114.

In some embodiments, the communication device 100 may be an electronic device, such as a laptop computer, a tablet computer, a mobile phone, a smart appliance, a gaming console, an access point, a desktop computer, a wearable device, or another suitable electronic device. The communication device 100 may be configured to implement one or more communication protocols (e.g., wireless local area network (WLAN) communication protocols, such as IEEE 802.11 communication protocols). In some embodiments, in addition to or instead of WLAN communication protocols, the communication device 100 may implement other protocols and related functionality to enable other types of communication (e.g., BLUETOOTH® (Bluetooth), Ethernet, worldwide interoperability for microwave access (WiMAX), powerline communication (PLC), etc.). Furthermore, in some embodiments, the communication device 100 may include one or more radio transceivers, processors, analog front-end (AFE) units, memory, other components, and/or other logic to implement the communication protocols and related functionality.

In one embodiment, the transmitter unit 102 and the receiver unit 106 may implement a common communication protocol. For example, the transmitter unit 102 and the receiver unit 106 may each be part of a WLAN communication unit of a mobile phone. In another embodiment, the transmitter unit 102 and the receiver unit 106 may implement different communication protocols. For example, the transmitter unit 102 may be part of a WLAN communication unit of a mobile phone; while the receiver unit 106 may be part of a WiMAX communication unit of the same mobile phone.

The transmitter processing unit 104 may generate a signal for transmission. After processing the transmit signal (e.g., by digital-to-analog conversion, filtering, mixing, etc.), the resultant transmit signal may be provided to a power amplifier of the transmitter processing unit 104. The transmitter unit 102 may transmit the signal after amplification by the power amplifier. In the field of wireless communications, a transmit signal may be mathematically represented using one or more equations. The transmit signal or “undistorted input signal” may be represented in either the Cartesian format by Eq. 1a or the polar (magnitude/phase) format by Eq. 1b.

x[k]=xᵢ[k]+jx_{q}[k] Eq. 1a

x[k]=|x[k]|e^{jθ[k]} Eq. 1b

In Eq. 1a, x[k] represents the original transmit signal at the k^{th} time instant; xᵢ[k] represents the in-phase (I) component of the original transmit signal at the k^{th} time instant; and x_{q}[k] represents the quadrature (Q) component of the original transmit signal at the k^{th} time instant. In Eq. 1b, |x[k]| represents the magnitude component of the original transmit signal at the k^{th} time instant; and θ[k] represents the phase component of the original transmit signal at the k^{th} time instant. In some embodiments, a portion of the transmit signal may leak from the transmitter unit 102 into the receiver unit 106. For example, the output of the power amplifier (or another non-linear processing component) may include harmonics of the transmit signal in addition to the original transmit signal. The harmonics of the transmit signal may cause non-linear interference (distortion) in the receiver unit 106. The distorted signal at the receiver unit 106 may be represented in the Cartesian format by Eq. 2.

$$y [ k ] = {\sum }_{p = 0}^{P 1} {c}_{p} {x}^{p} [ k ] \qquad Eq . 2$$

In Eq. 2, y[k] is the interference signal and represents the distorted version of the transmit signal x[k] that leaks from the transmitter unit 102 into the receiver unit 106. The variable p represents the exponent (or power) and consequently the harmonic of the transmit signal. In the Cartesian format, the magnitude and phase of the interference signal y[k] are determined by complex coefficients cₚ. Thus, in the Cartesian format, the interference signal may be represented as a complex weighted combination of various harmonics of the original transmit signal. It is noted that the term “complex” refers to a number that has an in-phase component (or “real component”) and a quadrature component (or “imaginary component”). Complex numbers may be expressed in the form A+jB where A and B are real numbers and j is an imaginary unit that satisfies the equation j²=−1.

Furthermore, in the Cartesian format, the magnitude component of the interference signal (“interference magnitude component”) and the phase component of the interference signal (“interference phase component”) are tied to each other by complex coefficients cₚ. Accordingly, the interference magnitude component and the interference phase component may not be modeled and estimated independent of each other. Instead, the same complex weighted combination of Eq. 2 may be used to estimate both the interference magnitude component and the interference phase component. Using the Cartesian format may not allow, for example, the interference magnitude component to be represented using a polynomial that only includes odd exponents (“odd-order polynomial”) and the interference phase component to be represented using a polynomial that only includes both odd and even exponents (“all-order polynomial”).

In contrast to the Cartesian format, a polar format allows the interference signal to be represented using an independent interference magnitude component and interference phase component. For example, in one embodiment, using the polar format may allow the interference magnitude component to be represented using an odd-order polynomial and the interference phase component to be represented using an all-order polynomial. The interference cancellation unit 110 may use the polar format to independently estimate the interference magnitude component and the interference phase component. Eq. 3 represents the interference signal at the receiver unit 106 in the polar format.

y=f(|x|)e^{jg(|x|+θ)} Eq. 3

In Eq. 3, the terms f(x) and g(x) represent the magnitude distortion and the phase distortion respectively. In Eq. 3, θ represents the undistorted phase component of the transmit signal. As depicted in Eq. 3, the phase component of the transmit signal has been separated out for convenience. The distortion that is caused by transmitter non-linearities (e.g., by the power amplifier, a switch, a driver amplifier, a filter, etc.) may be represented by magnitude distortion (AM/AM) characteristics and phase distortion (AM/PM) characteristics. For a power amplifier, the AM/AM characteristics may represent the change in the output power gain (e.g., in dB) versus input power, relative to small signal gain. The AM/PM characteristics may represent the change in the output phase (e.g., in degrees) versus input power, relative to small signal conditions.

In the polar format, the magnitude component of the interference signal may be estimated based, at least in part, on the magnitude distortion f(x), represented by Eq. 4. The phase component of the interference signal may be determined based, at least in part, on the phase distortion g(x), represented by Eq. 5. In one example, the magnitude distortion and the magnitude polynomial expansion may be determined from the AM/AM characteristics; while the phase distortion and the phase polynomial expansion may be determined from the AM/PM characteristics.

$$\begin{matrix}f ( x ) = {\sum }_{n = 0}^{N 1} {a}_{n} {x}^{n} & Eq . 4 \\ g ( x ) = {\sum }_{m = 0}^{M 1} {b}_{m} {x}^{m} & Eq . 5\end{matrix}$$

The magnitude polynomial expansion may be a first function of the absolute value (i.e., magnitude component) of the transmit signal. The phase polynomial expansion may be a second function of the magnitude component of the transmit signal. Reference to first function and second function are not intended to denote a particular sequence or ordering, but rather that the functions may be independent of each other. By using the magnitude polynomial expansion and the phase polynomial expansion, the interference signal is split into two independent polynomials—one for estimating the interference magnitude component and the other for estimating the interference phase component. In Eq. 4, aₙ represents real coefficients of the magnitude polynomial expansion (“magnitude coefficients”). In Eq. 5, bₙ represents real coefficients of the phase polynomial expansion (“phase coefficients”). It is noted that “real” coefficients represent non-complex numbers that do not have an imaginary or quadrature component. Furthermore, as depicted by Eq. 4 and Eq. 5, the magnitude coefficients and the phase coefficients are independent of each other. Likewise, the magnitude polynomial expansion and the phase polynomial expansion are independent of each other. The magnitude polynomial expansion and the phase polynomial expansion may have a different number of constituent polynomial terms in the polynomial expansion and/or a different polynomial degree. Each constituent polynomial term may be referred to as a “kernel.” For example, the magnitude polynomial expansion may include odd-order kernels (e.g., a₁|x|+a₃|x|³+a₅|x|⁵); while the phase polynomial expansion may include all-order kernels (e.g., b₁|x|+b₂|x|²+b₃|x|³). In this example, |x|, |x|³, and |x|⁵ may be the kernels of the magnitude polynomial expansion; while |x|, |x|², and |x|³ may be the kernels of the phase polynomial expansion.

The interference magnitude estimation unit 112 and the interference phase estimation unit 114 may independently estimate the interference magnitude component and the interference phase component, respectively. For example, the interference magnitude estimation unit 112 may determine an interference magnitude component based, at least in part, on a magnitude polynomial expansion and a transmit signal of a communication device. For example, the magnitude polynomial expansion may be a combination of: 1) magnitude coefficients and 2) the magnitude component of the transmit signal raised to a suitable exponent. Thus, the interference magnitude component may be determined by plugging the value of the magnitude component of the transmit signal into the magnitude polynomial expansion. The interference phase estimation unit 114 may determine an interference phase component based, at least in part, on a phase polynomial expansion and the transmit signal. The magnitude polynomial expansion and the phase polynomial expansion have different polynomial terms. For example, the phase polynomial expansion may be a combination of: 1) phase coefficients and 2) the magnitude component of the transmit signal raised to suitable exponents. Thus, the interference phase component may be determined by first plugging the value of the magnitude component of the transmit signal into the phase polynomial expansion. The resultant value may be summed with the phase component of the transmit signal to yield the interference phase component. The interference cancellation unit 110 may determine an interference signal based, at least in part, on the magnitude polynomial expansion and the phase polynomial expansion. For example, the interference magnitude component and the interference phase component may be converted from the polar format to the Cartesian format to yield the interference signal. Furthermore, the interference cancellation unit 110 may cancel at least a portion of the interference signal from a receive signal received by the communication device.

The interference magnitude component |y| may be represented by Eq. 6; while the interference phase component φ may be represented by Eq. 7.

|y|=f(|x|)=a₁|x|+a₂|x|²+a₃|x|³+ . . . Eq. 6

φ=g(|x|)+θ=b₁|x|+b₂|x|²+b₃|x|³+ . . . +θ Eq. 7

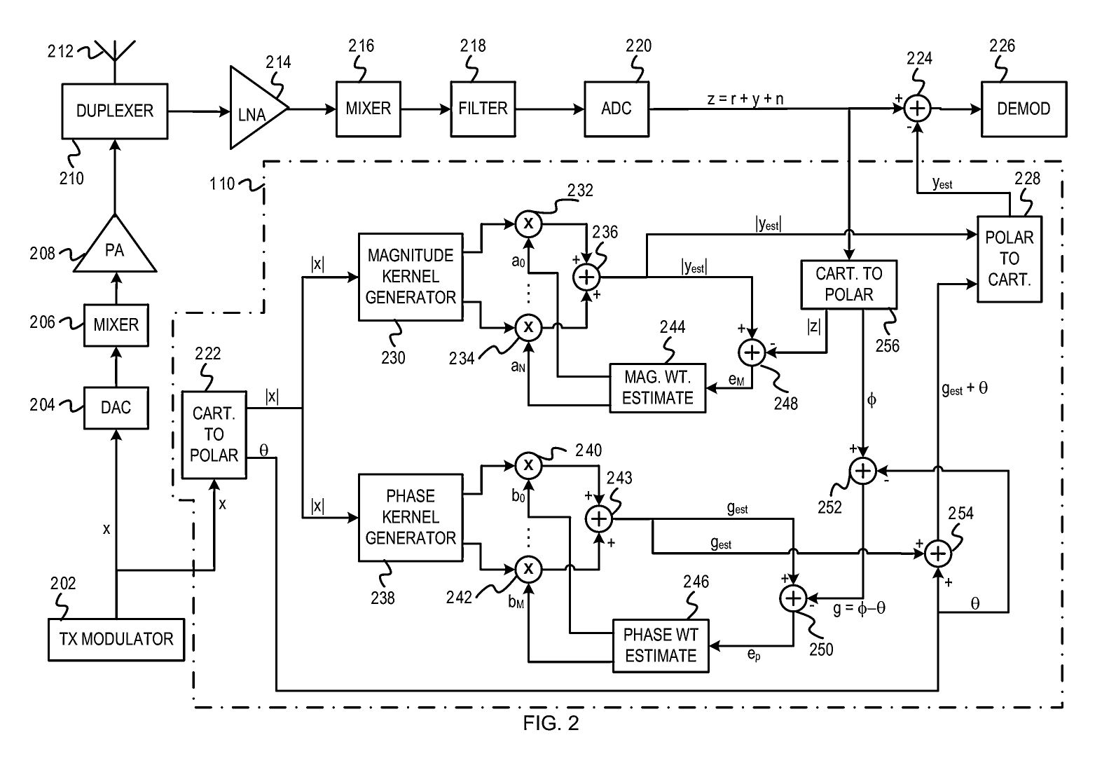

Eq. 3-Eq. 7 are not represented on a per-sample basis (e.g., x[k], y[k], etc.) for convenience and simplicity. The terms x, y, φ, θ for the equations Eq. 3-Eq. 7 may be represented as x[k], y[k], φ[k], θ[k] respectively, for the k^{th} sample in the digital domain. Operations for independently determining the interference magnitude component and the interference phase component will be further described in FIG. 2.

FIG. 2 is an example block diagram illustrating one embodiment of the communication device 100 including the transmitter unit 102 and the receiver unit 106. FIG. 2 depicts a baseband transmit (TX) modulator 202, a digital-to-analog converter (DAC) 204, a transmit mixer 206, a power amplifier 208, and a duplexer 210. In some embodiments, the TX modulator 202, the DAC 204, the mixer 206, and the power amplifier 208 may be implemented by the transmitter processing unit 104. The TX modulator 202 may generate a transmit signal (x) for transmission. The transmit signal may be represented by Eq. 1a or Eq. 1b. The DAC 204 may convert the transmit signal from a digital representation to an analog representation of the transmit signal. The mixer 206 may receive a local oscillator input and up-convert the baseband analog transmit signal to a higher frequency for transmission on the communication medium. The power amplifier 208 may amplify the transmit signal to an appropriate transmit power level. The duplexer 210 may enable bi-directional (“duplex”) communication via a shared antenna 212. The duplexer 210 may receive the transmit signal from the power amplifier 208 and transmit the signal via the antenna 212.

The receiver unit 106 may include processing components for receiving and processing a receive signal. The receiver unit 106 may receive a signal (z) via the antenna 212 and the duplexer 210. The receive signal may be provided to a low noise amplifier (LNA) 214, a mixer 216, a filter unit 218, and an analog-to-digital converter (ADC) 220. For example, the LNA 214 may amplify the receive signal; the mixer 216 may down-convert the receive signal to a suitable frequency for subsequent processing. The mixer 216 may down-convert the receive signal to baseband or another suitable intermediate frequency. The filter unit 218 may filter the receive signal; while the ADC 220 may convert the receive signal from an analog representation to a digital representation. The receive signal may include interference caused by the transmit signal leaking from the transmitter unit into the receiver unit. The receive signal including the interference may be represented by Eq. 8.

z[k]=r[k]+y[k]+n[k] Eq. 8

In Eq. 8, r[k] is the desired signal that was received from the device communicating with the receiver unit 106, y[k] is the interference (represented by Eq. 3) caused by the transmitter unit 102 at the receiver unit 106. n[k] represents the noise in the communication network (e.g., Additive White Gaussian Noise (AWGN)).

The interference cancellation unit 110 may receive the original transmit signal x from the TX modulator 202 in the Cartesian format. In FIG. 2, the interference cancellation unit 110 includes a Cartesian-to-polar converter 222. The Cartesian-to-polar converter 222 may convert the transmit signal from the complex Cartesian I/Q format (depicted in Eq. 1a) to a polar format (depicted in Eq. 1b). The polar format of the transmit signal includes a magnitude component |x| and a phase component θ that are independent of each other. The Cartesian-to-polar converter 222 provides the magnitude component of the transmit signal to magnitude kernel generator 230 and phase kernel generator 238. As will be further described below the phase component of the transmit signal may also be used to estimate the interference phase component.

The magnitude kernel generator 230 receives the magnitude component of the transmit signal |x| and generates appropriate kernels based on the magnitude polynomial expansion. For example, the magnitude polynomial expansion may be represented by f(x)=a₁|x|+a₃|x|³+a₅|x|⁵ . . . . In this example, the magnitude kernel generator 230 may generate the kernels |x|, |x|³, |x|⁵, etc. and provide the kernels to appropriate multipliers. Multipliers 232 and 234 may receive an appropriate kernel from the magnitude kernel generator 230 and multiply the kernel with the appropriate magnitude coefficient. It is noted that the interference magnitude estimation unit 112 may include any suitable number of multipliers depending on the number of kernels in the magnitude polynomial expansion. For example, if the magnitude polynomial expansion is represented by f(x)=a₁|x|+a₃|x|³+a₅|x|⁵, the interference magnitude estimation unit may include three multipliers. The output of the first, second, and third multipliers may be a₁|x|, a₃|x|³, a₅|x|⁵ respectively as described above. Referring to FIG. 2, the output of the multipliers 232 and 234 is provided to adder 236. The adder 236 may sum the outputs of the multipliers 232 and 234 to estimate the interference magnitude component |yₑₛₜ|.

The phase kernel generator 238 also receives the magnitude component of the transmit signal |x| and generates appropriate kernels based on the phase polynomial expansion. For example, the phase polynomial expansion may be represented by g(x)=b₀+b₁|x|+b₂|x|²+b₃|x|³. In this example, the phase kernel generator 238 may generate the kernels 1, |x|, |x|², |x|³, and provide the kernels to the appropriate multipliers. In FIG. 2, multipliers 240 and 242 may receive an appropriate kernel from the phase kernel generator 238 and multiply the kernel with the appropriate phase coefficient. It is noted that the interference phase estimation unit 114 may include any suitable number of multipliers depending on the number of kernels in the phase polynomial expansion. Referring to the above example where the phase polynomial expansion is represented by g(x)=b₀+b₁|x|+b₂|x|²+b₃|x|³, the interference phase estimation unit 114 may include four multipliers. The output of the first, second, third, and fourth multipliers may be b₀, b₁|x|, b₂|x|², b₃|x|³ respectively. Referring to FIG. 2, the output of the multipliers 240 and 242 is provided to adder 243. The adder 243 sums the outputs of the multipliers 240 and 242 to yield an estimated phase distortion gₑₛₜ. The estimated phase distortion gₑₛₜ and the phase component θ of the transmit signal are provided to adder 254. The output of the adder 254 is the estimated interference phase component (gₑₛₜ+θ).

In some embodiments, the magnitude polynomial expansion and the phase polynomial expansion may include kernels at a current time instant. In other words, the magnitude polynomial expansion and the phase polynomial expansion may be represented using x[n] raised to suitable exponents, where n is the current time instant. However, embodiments are not so limited. In other embodiments, the magnitude polynomial expansion and the phase polynomial expansion may include delay terms. For example, a memory effect of various non-linear components of the communication device may be taken into account.

In addition to the sample of the magnitude component of the transmit signal at the current time instant (i.e., |x[n]|), in some embodiments, the magnitude polynomial expansion and the phase polynomial expansion may include terms for samples of the magnitude component of the transmit signal at previous time instants (i.e., |x[n−1]|, |x[n−2]|, etc.). For example, when the memory effect is taken into consideration, the magnitude polynomial expansion may be represented by f(x)=a₁₀|x[n]|+a₁₁|x[n−1]|+a₁₂|x[n−2]|+a₃₀|x[n]|³+a₃₁|x[n−1]|³+a₃₂|x[n−2]|³+a₅₀|x[n]|⁵+a₅₁|x[n−1]|⁵+a₅₂|x[n−2]|⁵+ . . . . As another example, when the memory effect is taken into consideration, the phase polynomial expansion may be represented by g(x)=b₀₀+b₁₀|x|+b₁₁|x[n−1]|+b₁₂|x[n−2]|+b₂₀|x|²+b₂₁|x[n−1]|²+a₂₂|x[n−2]|²+b₃₀|x|³+b₃₁|x[n−1]|³+b₃₂|x[n−2]|³+ . . . .

In some embodiments, the number of kernels that are generated by the magnitude kernel generator 230 and the phase kernel generator 238 may depend on the configuration of the communication device and/or the characteristics of the non-linear processing components (e.g., the power amplifier 208). For example, distortion characteristics of the non-linear processing components may be characterized during a manufacturing or testing process to determine the magnitude distortion (e.g., AM/AM graph) and the phase distortion (e.g., AM/PM graph) of the non-linear processing components. The magnitude polynomial expansion and the phase polynomial expansion may be mathematical representations of the AM/AM graph and the AM/PM graph respectively. The magnitude kernel generator 230 and the phase kernel generator 238 may generate the appropriate number of kernels depending on the magnitude polynomial expansion and the phase polynomial expansion respectively.

The interference magnitude component |yₑₛₜ| and the interference phase component gₑₛₜ+θ are provided to a polar-to-Cartesian converter 228. The polar-to-Cartesian converter 228 may convert the interference magnitude component and the interference phase component from the polar format to a Cartesian representation of an interference signal yₑₛₜ. Subtractor 224 receives the interference signal yₑₛₜ and the receive signal y at the output of the ADC 220. The subtractor 224 may subtract the interference signal yₑₛₜ from the receive signal y to minimize or eliminate the interference in the receive signal that was caused by the transmitter unit. The resultant receive signal with minimal interference may be provided to a demodulator 226 and to subsequent processing units.

In addition, the receive signal z may also be used to refine the magnitude coefficients (a₀, . . . a_{N}) and the phase coefficients (b₀, . . . b_{N}). The receive signal z may be provided to a Cartesian-to-polar converter 256. The Cartesian-to-polar converter 256 may convert the receive signal z from the Cartesian format to a polar format. In the polar format, the receive signal may be represented by a magnitude component |z| and a phase component φ. The magnitude component of the receive signal may be used to refine the magnitude coefficients; while the phase component of the receive signal may be used to refine the phase coefficients. Subtractor 248 receives the interference magnitude component |yₑₛₜ| and the magnitude component of the receive signal |z|. The subtractor 248 may subtract the magnitude component of the receive signal from the interference magnitude component to yield a magnitude error e_{M}. The magnitude error e_{M} is provided to a magnitude weight estimator 244. The magnitude weight estimator 244 can use the magnitude error and previous magnitude coefficients to refine the previous magnitude coefficients and determine updated magnitude coefficients. As depicted in FIG. 2, the magnitude weight estimator 244 may apply the updated magnitude coefficients to the multipliers 232 and 234. The magnitude weight estimator 244 may use a least squares estimation technique or another suitable estimation technique to refine the magnitude coefficients at each iteration. The magnitude weight estimator 244 may refine the magnitude coefficients until the magnitude error e_{M} is zero or below a predefined magnitude error threshold.

Subtractor 252 receives the phase component of the receive signal φ and the phase component of the transmit signal θ. The subtractor 252 may subtract the phase component of the transmit signal from the phase component of the transmit signal to yield a received phase distortion g=φ−θ. The received phase distortion g and the estimated phase distortion gₑₛₜ are provided to subtractor 250. The subtractor 250 may subtract the received phase distortion from the estimated phase distortion to yield a phase error eₚ. The phase error eₚ is provided to a phase weight estimator 246. The phase weight estimator 246 can use the phase error and previous phase coefficients to refine the previous phase coefficients and determine updated phase coefficients. As depicted in FIG. 2, the phase weight estimator 246 may apply the updated phase coefficients to the multipliers 240 and 242. The phase weight estimator 246 may use a least squares estimation technique or another suitable estimation technique to refine the phase coefficients at each iteration. The phase weight estimator 246 may refine the phase coefficients until the phase error eₚ is zero or below a predefined phase error threshold.

In some embodiments, the transmitter processing unit 104 of FIG. 1 may include the TX modulator 202, the DAC 204, the transmit mixer 206, and the power amplifier 208. The receiver processing unit 108 of FIG. 1 may include the LNA 214, the receive mixer 216, the filter unit 218, the ADC 220, the subtractor 224, and the demodulator 226. In some embodiments, the transmitter processing unit 104 may include the duplexer 210. However, in other embodiments, the receiver processing unit 108 may include the duplexer 210. The interference cancellation unit 110 of FIG. 1 may include: A) the Cartesian-to-polar converters 222 and 256; B) the polar-to-Cartesian converter 228; C) the magnitude kernel generator 230; D) the phase kernel generator 238; E) the magnitude weight estimator 244; F) the phase weight estimator 246; G) the subtractors 248, 250, and 252; H) the adders 236, 243, and 254; and I) the multipliers 232, 234, 240, and 242.

In some embodiments, the interference magnitude estimation unit 112 of FIG. 1 may implement functionality that estimates the magnitude component of the interference signal. The interference phase estimation unit 114 of FIG. 1 may implement functionality that estimates the phase component of the interference signal. The interference magnitude estimation unit 112 and the interference phase estimation unit 114 may be independent of each other. In some embodiments, the interference magnitude estimation unit 112 and the interference phase estimation unit 114 may not share the same processing components. Referring to the example of FIG. 2, the interference magnitude estimation unit 112 may include: A) the magnitude kernel generator 230, B) the magnitude weight estimator 244, C) the multipliers 232 and 234, D) the adder 236 and E) the subtractor 248. The interference phase estimation unit 114 may include: A) the phase kernel generator 238, B) the phase weight estimator 246, C) the adders 243 and 254, D) the subtractors 250 and 252, and E) the multipliers 240 and 242. It is noted that in some embodiments, the transmitter processing unit 104, the receiver processing unit 108, and/or the interference cancellation unit 110 may include other components and functionality not depicted in FIG. 2. For example, the transmitter processing unit 104 may include a filter unit, a modulation unit, etc. As another example, the receiver processing unit 108 may include an automatic gain control (AGC) unit and decoder unit, etc. Furthermore, some of the processing components depicted in FIG. 2 may be implemented as part of a communication unit that is separate from the transmitter unit 102 and the receiver unit 106. For example, the power amplifier 208 and/or the duplexer 210 may be implemented on an analog front end (AFE) that is external to the transmitter unit 102 and the receiver unit 106.

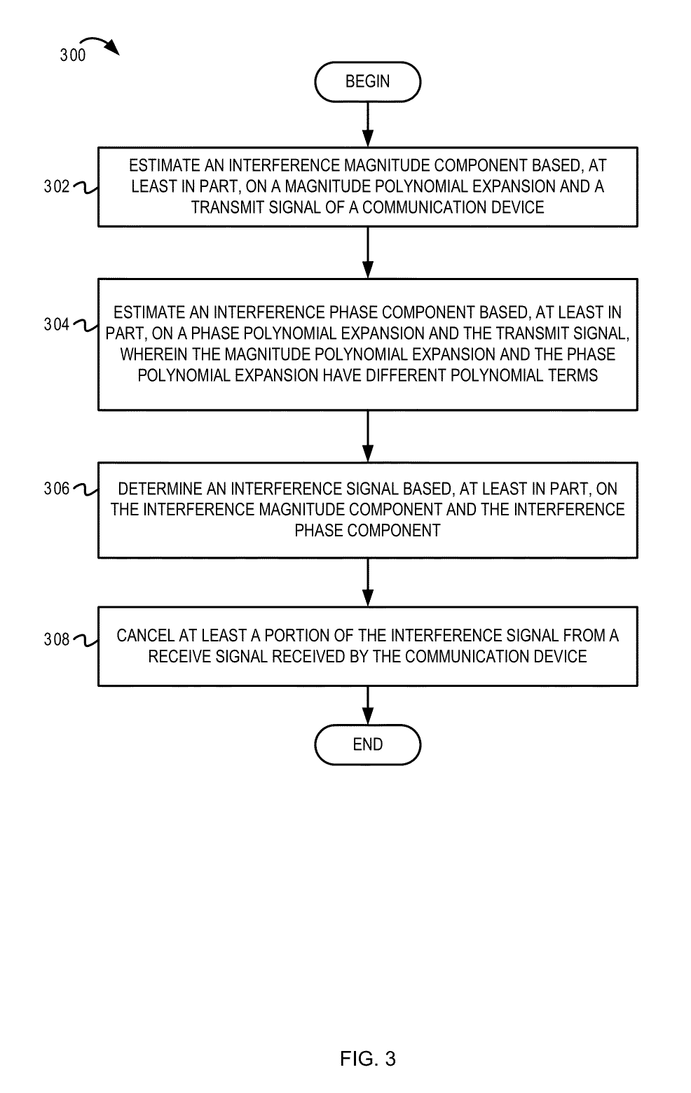

FIG. 3 is a flow diagram (“flow”) 300 illustrating example operations for interference cancellation using polar expressions. The flow 300 begins at block 302.

At block 302, an interference magnitude component is estimated based, at least in part, on a magnitude polynomial expansion and a transmit signal of a communication device. In some embodiments, the interference cancellation unit 110 may determine a magnitude component and a phase component of the transmit signal. The interference magnitude estimation unit 112 may use the magnitude component of the transmit signal and the magnitude polynomial expansion to determine the interference magnitude component as described above with reference to FIGS. 1 and 2. For example, the interference magnitude estimation unit 112 may combine the magnitude component of the transmit signal with the magnitude polynomial expansion to estimate the interference magnitude component. In some embodiments, the magnitude polynomial expansion may be determined based, at least in part, on magnitude distortion characteristics of non-linear processing components (e.g., a power amplifier, switches, a driver amplifier, filters, etc.) of the communication device. The magnitude polynomial expansion and the interference magnitude component may be represented by Eq. 4 and Eq. 6. A magnitude kernel generator may generate a suitable number of kernels from the magnitude component of the transmit signal depending on the magnitude polynomial expansion. The interference magnitude component may be determined by combining the kernels with appropriate magnitude coefficients. The flow continues at block 304.

At block 304, an interference phase component is estimated based, at least in part, on a phase polynomial expansion and the transmit signal, where the magnitude polynomial expansion and the phase polynomial expansion have different polynomial terms. For example, the interference phase estimation unit 114 may determine the interference phase component as described above with reference to FIGS. 1 and 2. The interference phase estimation unit 114 may combine the magnitude component of the transmit signal with the phase polynomial expansion to estimate the interference phase component. In some embodiments, the phase polynomial expansion may be determined based, at least in part, on phase distortion characteristics of a non-linear processing component of the communication device. The phase polynomial expansion and the interference phase component may be represented by Eq. 5 and Eq. 7. A phase kernel generator may generate a suitable number of kernels from the magnitude component of the transmit signal depending on the phase polynomial expansion. The estimated phase distortion may be determined by combining the phase kernels with phase coefficients. The estimated phase distortion may be added to the phase component of the transmit signal to generate the interference phase component.

The phase polynomial expansion that is used to estimate the interference phase component is independent from the magnitude polynomial expansion that is used to estimate the interference magnitude component. Furthermore, the magnitude polynomial expansion and the phase polynomial expansion may have different polynomial terms (also referred to as kernels) and/or different polynomial degrees. This can allow for a more precise representation of the magnitude and phase distortion generated by a transmitter unit at a receiver unit of the communication device. For example, the magnitude polynomial expansion may allow the interference magnitude component to be described as an approximately accurate representation of the AM/AM characteristics of the non-linear processing component (e.g., a power amplifier, a switch, a driver amplifier, a filter, etc.) of the communication device. As another example, the phase polynomial expansion may allow the interference phase component to be described as an approximately accurate representation of the AM/PM characteristics of the non-linear processing component of the communication device. Using independent magnitude and phase polynomial expansions may also be helpful when the AM/AM characteristics and the AM/PM characteristics are represented by different graphs. For example, the AM/AM characteristics may be represented by an odd-order polynomial and the AM/PM characteristics may be represented by an all-order polynomial. The flow continues at block 306.

At block 306, an interference signal is determined based, at least in part, on the interference magnitude component and the interference phase component. For example, the interference cancellation unit 110 may determine the interference signal as described above with reference to FIGS. 1 and 2. The interference magnitude component and the interference phase component may be converted from a polar format to a Cartesian format to yield the interference signal. The flow continues at block 308.

At block 308, at least a portion of the interference signal is cancelled from a receive signal received by the communication device. For example, the receiver unit 106 may receive the receive signal. The interference signal may be subtracted from the receive signal to cancel or minimize the interference and distortion caused by the transmitter unit 102 as described above with reference to FIGS. 1 and 2. The resultant receive signal (with reduced interference) may be provided to subsequent processing units for demodulation, decoding, and data recovery. From block 308, the flow ends.

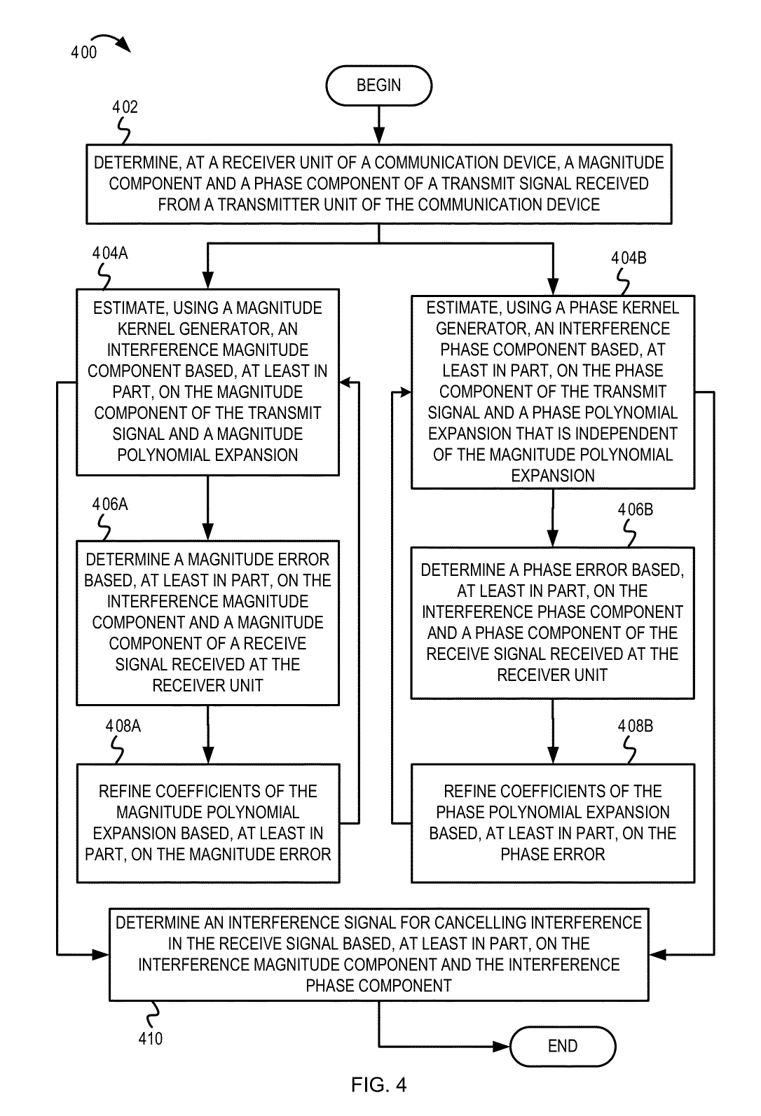

FIG. 4 is a flow diagram 400 illustrating example operations of another embodiment for interference cancellation using an independent interference magnitude component and interference phase component. The flow begins at block 402.

At block 402, a receiver unit of a communication device determines a magnitude component and a phase component of a transmit signal received from a transmitter unit of the communication device. Referring to the example of FIG. 1, the interference cancellation unit 110 of the receiver unit 106 may receive an original undistorted transmit signal from the transmitter unit 102. In some embodiments, the transmitter unit and the receiver unit may implement a common communication protocol on the communication device. For example, the transmitter unit may be a WLAN-capable transmitter unit; while the receiver unit may be a WLAN-capable receiver unit. In another embodiment, the transmitter unit and the receiver unit may implement difference communication protocols on the communication device. The transmitter unit and the receiver unit may each be implemented on a distinct communication unit. The communication units may be collocated or proximate to each other. For example, the transmitter unit may be a WLAN-capable transmitter unit; while the receiver unit may be a WiMAX-capable receiver unit.

In some embodiments, the receiver unit may receive the transmit signal from the transmitter unit in a Cartesian I/Q format as depicted by Eq. 1a. The receiver unit may convert the transmit signal from the Cartesian I/Q format to the polar format to yield an independent magnitude component and phase component of the transmit signal. In another embodiment, the receiver unit may receive the magnitude component and the phase component from the transmitter unit as depicted by Eq. 1b. The flow continues at block 404A and 404B. Operations described in blocks 404A, 406A, and 408A relate to estimating the interference magnitude component; while operations described in blocks 404B, 406B, and 408B relate to estimating the interference phase component.

At block 404A, a magnitude kernel generator is used to estimate an interference magnitude component based, at least in part, on the magnitude component of the transmit signal and a magnitude polynomial expansion. For example, the interference magnitude estimation unit 112 may determine the interference magnitude component as described above with reference to FIGS. 1 and 2. The magnitude kernel generator may generate a suitable number of kernels from the magnitude component of the transmit signal depending on the magnitude polynomial expansion. The magnitude polynomial expansion may be a mathematical representation of the magnitude distortion generated by the transmitter unit (e.g., power amplifier or another suitable non-linear processing component) at the receiver unit. For example, if the magnitude polynomial expansion is represented by f(x)=a₁|x|+a₃|x|³, the interference magnitude component may be estimated as |y|=f(x) as described above with reference to Eq. 6. In this example, the magnitude kernel generator may generate magnitude kernels |x| and |x|³. The interference magnitude component may be determined by combining the magnitude kernels with appropriate magnitude coefficients. The flow continues at blocks 406A and 410.

At block 406A, a magnitude error is determined based, at least in part, on the interference magnitude component and a magnitude component of a receive signal received at the receiver unit. In some embodiments, the receive signal may be represented in the Cartesian format. Consequently, the receiver unit may convert the receive signal from the Cartesian format to the polar format to generate a magnitude component and a phase component of the receive signal. The magnitude component of the receive signal may be subtracted from the interference magnitude component (determined at block 404A) to yield the magnitude error. The magnitude error may be used to drive adaptation operations for refining magnitude coefficients of the magnitude polynomial expansion. The flow continues at block 408A.

At block 408A, coefficients of the magnitude polynomial expansion are refined based, at least in part, on the magnitude error. For example, a magnitude weight estimator may refine the magnitude coefficients based, at least in part, on the magnitude error and the magnitude coefficients used in a preceding iteration. In some embodiments, the magnitude weight estimator may execute a least squares estimation technique or another suitable estimation technique to refine the magnitude coefficients. From block 408A, the flow loops back to block 404A. The magnitude polynomial expansion may be updated based on the refined magnitude coefficients and subsequent operations for estimating the interference magnitude component may use the updated magnitude polynomial expansion.

At block 404B, a phase kernel generator is used to estimate an interference phase component based, at least in part, on the phase component of the transmit signal and a phase polynomial expansion that is independent of the magnitude polynomial expansion. For example, the interference phase estimation unit 114 may determine the interference phase component as described above with reference to FIGS. 1 and 2. The phase kernel generator may generate a suitable number of kernels from the magnitude component of the transmit signal depending on the phase polynomial expansion. The phase polynomial expansion may be a mathematical representation of the phase distortion generated by the transmitter unit (e.g., power amplifier or another suitable non-linear processing component) at the receiver unit. For example, if the phase polynomial expansion is represented by g(x)=b₁|x|+b₂|x|²+b₃|x|³, the phase kernel generator may generate phase kernels |x|, |x|², and |x|³. The estimated phase distortion may be determined by combining the phase kernels with appropriate phase coefficients. The estimated phase distortion may be added to the phase component of the transmit signal to generate the interference phase component. It is noted that the phase polynomial expansion that is used to determine the interference phase component is independent from the magnitude polynomial expansion that is used to determine the interference magnitude component. Furthermore, the magnitude polynomial expansion and the phase polynomial expansion may have different number of kernels with a different exponent. The flow continues at blocks 406B and 410.

At block 406B, a phase error is determined based, at least in part, on the interference phase component and a phase component of the receive signal received at the receiver unit. In some embodiments, the phase component of the transmit signal may be removed from the phase component of the receive signal to isolate the distortion component of the interference phase component as described above in FIG. 2. For example, the phase component of the transmit signal may be subtracted from the phase component of the receive signal to yield a received phase distortion. The received phase distortion may be subtracted from the estimated phase distortion to yield the phase error. As described in FIG. 2, the estimated phase distortion represents the difference between the interference phase component (determined at block 406B) and the phase component of the transmit signal. The phase error may be used to drive adaptation operations for refining phase coefficients of the phase polynomial expansion. The flow continues at block 408B.

At block 408B, coefficients of the phase polynomial expansion are refined based, at least in part, on the phase error. For example, a phase weight estimator may refine the phase coefficients based, at least in part, on the phase error and the phase coefficients used in a preceding iteration. In some embodiments, the phase weight estimator may execute a least squares estimation technique or another suitable estimation technique to refine the phase coefficients. From block 408B, the flow loops back to block 404B. The phase polynomial expansion may be updated based on the refined phase coefficients and subsequent operations for estimating the interference phase component may use the updated phase polynomial expansion.

At block 410, an interference signal is determined for cancelling interference in the receive signal based, at least in part, on the interference magnitude component and the interference phase component. The interference magnitude component and the interference phase component may be converted from the polar format to a Cartesian I/Q format to yield the interference signal. The interference signal may be used to cancel interference and minimize distortion caused by the transmitter unit at the receiver unit as described above with reference to FIGS. 1 and 2. The resultant receive signal (with little to no interference) may be provided to subsequent processing units for demodulation, decoding, and data recovery. From block 410, the flow ends.

FIGS. 1-4 and the operations described herein are examples meant to aid in understanding embodiments and should not be used to limit embodiments or limit scope of the claims. Embodiments may perform additional operations, fewer operations, operations in a different order, operations in parallel, and some operations differently. For example, FIG. 2 illustrates one example of the interference cancellation using an independent interference magnitude component and interference phase component. However, embodiments are not so limited. In other embodiment, the result of subtracting the estimated interference signal (yₑₛₜ) from the receive signal (y) may be used to refine the magnitude polynomial coefficients and the phase polynomial coefficients. For example, the receive error (y−yₑₛₜ) may be converted from a Cartesian format to a polar format to yield a receive magnitude error and a receive phase error. The receive magnitude error may be provided to the magnitude weight estimator; while the receive phase error may be provided to the phase weight estimator. In other embodiments, other suitable techniques may be implemented for independently refining the magnitude coefficients and the phase coefficients.

Although FIG. 2 describes the interference magnitude component and the interference phase component being converted from the polar format to the Cartesian format prior to interference cancellation, embodiments are not so limited. In other embodiments, interference cancellation may be performed in the polar format. For example, after receiving the receive signal (z), the receiver unit 106 may convert the receive signal from the Cartesian format to the polar format. The receiver unit 106 may include processing units (e.g., mixers, ADC units, etc.) to process the receive signal in the polar format. In this embodiment, the interference magnitude component and the interference phase component may not be converted from the polar format to the Cartesian format. Instead, the interference magnitude component may be subtracted from the magnitude component of the receiver signal. Likewise, the interference phase component may be subtracted from the phase component of the receive signal.

Although examples describe the interference cancellation unit 110 receiving the transmit signal from the transmitter unit 102 in the Cartesian format and converting the transmit signal from the Cartesian format to the polar format for estimating the interference signal, embodiments are not so limited. In other embodiments, the transmitter unit 102 may convert the transmit signal from the Cartesian format to the polar format. Alternatively, the transmitter unit 102 may generate the transmit signal in the polar format. The transmitter unit 102 may provide the magnitude component and the phase component of the transmit signal to the receiver unit 106. For example, the transmitter unit 102 may include a polar modulator or a COordinate Rotation DIgital Computer (CORDIC) to generate the magnitude and phase components of the transmit signal.

Although the Figures describe the interference cancellation unit 110 processing a digital representation of the transmit signal to determining the interference magnitude component and the interference phase component, embodiments are not so limited. In other embodiments, the interference cancellation unit 110 may use an analog representation of the transmit signal (e.g., the output of the DAC 204) to determine the interference magnitude component and the interference phase component. Likewise, the interference cancellation unit 110 may use an analog representation of the receive signal (e.g., at the input of the ADC 220) to refine the magnitude coefficients and the phase coefficients.

As depicted in Eq. 6, the interference magnitude component may be represented as a magnitude polynomial expansion of the transmit signal. As depicted in Eq. 7, the interference phase component may be represented as a sum of the phase component of the transmit signal and the phase distortion. Accordingly, the phase polynomial expansion may be represented by the phase distortion.

In some embodiments, the transmitter unit 102 and the receiver unit 106 may implement different communication protocols. For example, the transmitter unit 102 may implement a WLAN communication protocol, such as an IEEE 802.11 communication protocol. The receiver unit 106 may implement a WiMAX communication protocol. Alternatively, the transmitter unit 102 and the receiver unit 106 may each implement other suitable distinct wired or wireless communication protocols (e.g., Bluetooth, Ethernet, PLC, WiMAX, WLAN, etc.). In this embodiment, the transmitter unit 102 may use suitable coexistence techniques to provide the original transmit signal to the interference cancellation unit 110 of the receiver unit 106. Alternatively, the transmitter unit 102 and the receiver unit 106 may implement at least one common communication protocol so that the transmitter unit 102 can provide the transmit signal to the receiver unit 106 using the common communication protocol.

In some embodiments, the receiver unit 106 may estimate the interference signal using at least two different techniques and select one of the estimated interference signals to cancel from a received signal. For example, the receiver unit 106 may estimate a first interference signal from a transmit signal using a Cartesian approach. The first interference signal may be determined using a complex polynomial expansion that includes both the magnitude component and the phase component of the interference signal. The receiver unit 106 may also estimate a second interference signal from the same transmit signal using the polar approach described above with reference to FIGS. 1-4. The second interference signal may be determined using a magnitude polynomial expansion and a phase polynomial expansion that are independent of each other. In one embodiment, the receiver unit 106 may compare the first interference signal and the second interference signal. The receiver unit 106 may select one of the first interference signal and the second interference signal to represent the interference/distortion generated by the transmitter unit 102 at the receiver unit 106. Selection between the first interference signal and the second interference signal may be based on one or more factors, such as a transmit frequency threshold, power level threshold, and/or a configurable parameter. The receiver unit 106 may then use the selected interference signal to cancel interference from the receive signal.

In another embodiment, the receiver unit 106 may use the first interference signal to cancel interference from the receive signal and yield a resultant first output signal. The receiver unit 106 may use the second interference signal to cancel interference from the receive signal and yield a resultant second output signal. The receiver unit 106 may compare the first output signal and the second output signal. The receiver unit 106 may select one of the first output signal and the second output signal that best minimizes the interference/distortion generated by the transmitter unit 102 at the receiver unit 106. The receiver unit 106 may then use the selected output signal for subsequent decoding and processing.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

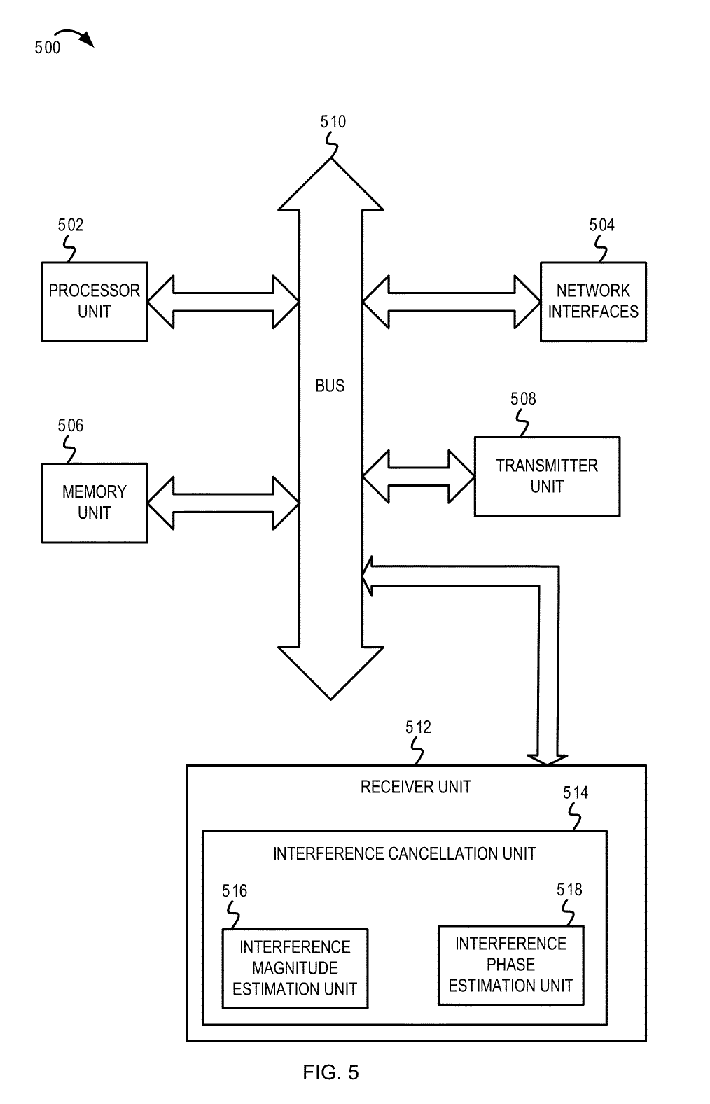

FIG. 5 is a block diagram of one embodiment of an electronic device 500 including a mechanism for minimizing interference using polar expressions. In some embodiments, the electronic device 500 can be a laptop computer, a tablet computer, a netbook, a mobile phone, a smart appliance, a wearable device, a gaming console, a desktop computer, a network bridge device, or another suitable electronic device that includes communication capabilities. The electronic device 500 includes a processor unit 502 (possibly including multiple processors, multiple cores, multiple nodes, and/or implementing multi-threading, etc.). The electronic device 500 includes a memory unit 506. The memory unit 506 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of computer-readable storage media. The electronic device 500 also includes a bus 510 (e.g., PCI, ISA, PCI-Express, HyperTransport®, InfiniBand®, NuBus, AHB, AXI, etc.) and network interfaces 504. The processor unit 502, the memory unit 506, and the network interfaces 504 are coupled to the bus 510. The network interfaces 504 include a wireless network interface (e.g., a WLAN interface, a Bluetooth interface, a WiMAX interface, a ZigBee® interface, a Wireless USB interface, etc.) and/or a wired network interface (e.g., a PLC interface, an Ethernet interface, etc.). Furthermore, in some embodiments, the electronic device 500 can execute IEEE 1905.1 protocols for implementing hybrid communication functionality.

The electronic device 500 also includes transmitter unit 508 and a receiver unit 512 that are each coupled with the bus 510. In some embodiments, the transmitter unit 508 and the receiver unit 512 may implement the same communication protocol. In another embodiment, the transmitter unit 508 and the receiver unit 512 may each implement a different communication protocol. The receiver unit 512 includes an interference cancellation unit 514. The interference cancellation unit 514 includes an interference magnitude estimation unit 516 and an interference phase estimation unit 518. The interference cancellation unit 514 may receive a transmit signal from the transmitter unit 508. The interference cancellation unit 514 can use a polar representation of the transmit signal to independently model each of the magnitude component and the phase component of the interference signal as described above with reference to FIGS. 1-4. The interference magnitude estimation unit 516 may estimate the interference magnitude component based, at least in part, on a magnitude polynomial expansion, magnitude coefficients, and a magnitude component of the transmit signal. The interference phase estimation unit 518 may estimate the interference phase component based, at least in part, on a phase polynomial expansion, phase coefficients, the magnitude component of the transmit signal, and the phase component of the transmit signal. Additionally, the interference magnitude estimation unit 516 may refine the magnitude coefficients based, at least in part, on the interference magnitude component and a magnitude component of a receive signal received at the receiver unit 512. Likewise, the interference phase estimation unit 518 may refine the phase coefficients based, at least in part, on the interference phase component and a phase component of the receive signal. The interference signal may be determined using the interference magnitude component and the interference phase component. The interference signal may be combined with the receive signal to minimize the interference caused by the transmitter unit 508 at the receiver unit 512.

Any one of these functionalities may be partially (or entirely) implemented in hardware and/or on the processor unit 502. For example, the functionality may be implemented with an application specific integrated circuit (ASIC), in logic implemented in the processor unit 502, in a co-processor on a peripheral device or card, etc. In some embodiments, the interference cancellation unit 514 can be implemented on a system-on-a-chip (SoC), an ASIC, or another suitable integrated circuit to enable communication by the electronic device 500. In some embodiments, the interference cancellation unit 514 may include additional processors and memory, and may be implemented in one or more integrated circuits on one or more circuit boards of the electronic device 500. Further, realizations may include fewer or additional components not illustrated in FIG. 5 (e.g., video cards, audio cards, additional network interfaces, peripheral devices, etc.). For example, in addition to the processor unit 502 coupled with the bus 510, the transmitter unit 508, the receiver unit 512, and/or the interference cancellation unit 514 may include at least one additional processor unit. As another example, although illustrated as being coupled to the bus 510, the memory unit 506 may be coupled to the processor unit 502.

While the embodiments are described with reference to various implementations and exploitations, it will be understood that these embodiments are illustrative and that the scope of the present disclosure is not limited to them. In general, techniques for minimizing interference using an independent interference magnitude component and interference phase component as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the present disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present disclosure.

What is claimed is:

1. A method for interference cancellation, the method comprising:
estimating an interference magnitude component based, at least in part, on a magnitude polynomial expansion and a transmit signal of a communication device;
estimating an interference phase component based, at least in part, on a phase polynomial expansion and the transmit signal, wherein the magnitude polynomial expansion and the phase polynomial expansion have different polynomial terms;
determining an interference signal based, at least in part, on the interference magnitude component and the interference phase component; and
cancelling at least a portion of the interference signal from a receive signal received by the communication device.

2. The method of claim 1, wherein the interference magnitude component and the interference phase component are independently determined.

3. The method of claim 2, wherein the magnitude polynomial expansion and the phase polynomial expansion are based, at least in part, on distortion characteristics of a power amplifier of the communication device.

4. The method of claim 1, wherein said determining the interference signal comprises:
converting the interference magnitude component and the interference phase component from a polar format to the interference signal that is represented in a Cartesian format.

5. The method of claim 1, wherein said estimating the interference magnitude component comprises:
combining a magnitude component of the transmit signal with the magnitude polynomial expansion to estimate the interference magnitude component.

6. The method of claim 1, wherein said estimating the interference phase component comprises:
combining a magnitude component of the transmit signal with the phase polynomial expansion to estimate a phase distortion component; and
adding the phase distortion component to a phase component of the transmit signal to estimate the interference phase component.

7. The method of claim 1, further comprising:
receiving the transmit signal from a transmitter unit of the communication device; and
converting the transmit signal from a Cartesian format to a polar format,
wherein the interference magnitude component and the interference phase component are estimated using at least part of the polar format of transmit signal.

8. The method of claim 1, further comprising:
receiving the receive signal at a receiver unit of the communication device;
determining a magnitude component of the receive signal and a phase component of the receive signal;
determining an interference magnitude error based, at least in part, on the interference magnitude component and the magnitude component of the receive signal; and
determining an interference phase error based, at least in part, on the interference phase component and the phase component of the receive signal.

9. The method of claim 8, wherein said determining the interference magnitude error comprises:
subtracting the magnitude component of the receive signal from the interference magnitude component to yield the interference magnitude error.

10. The method of claim 8, wherein said determining the interference phase error comprises:
subtracting the phase component of the receive signal from a phase component of the transmit signal to yield a phase difference value; and
subtracting the phase difference value from the interference phase component to yield the interference phase error.

11. The method of claim 8, further comprising:
refining magnitude coefficients of the magnitude polynomial expansion based, at least in part, on the interference magnitude error; and
refining phase coefficients of the phase polynomial expansion based, at least in part, on the interference phase error.

12. The method of claim 1, further comprising:
receiving, at a receiver unit of the communication device, a magnitude component of the transmit signal and a phase component of the transmit signal from a transmitter unit of the communication device, wherein the magnitude component of the transmit signal is independent of the phase component of the transmit signal.

13. The method of claim 1, wherein the transmit signal is associated with a first communication protocol and the receive signal is associated with a second communication protocol different from the first communication protocol.

14. A communication device comprising:
a processor unit; and
an interference cancellation unit coupled with the processor unit, the interference cancellation unit configured to:
estimate an interference magnitude component based, at least in part, on a magnitude polynomial expansion and a transmit signal of the communication device;
estimate an interference phase component based, at least in part, on a phase polynomial expansion and the transmit signal, wherein the magnitude polynomial expansion and the phase polynomial expansion have different polynomial terms;
determine an interference signal based, at least in part, on the interference magnitude component and the interference phase component; and
cancel at least a portion of the interference signal from a receive signal received by the communication device.

15. The communication device of claim 14, wherein the interference cancellation unit further comprises:
a magnitude kernel generator configured to determine the magnitude polynomial expansion; and
a phase kernel generator configured to determine the phase polynomial expansion.

16. The communication device of claim 14, wherein the interference cancellation unit configured to determine the interference signal comprises the interference cancellation unit configured to:
convert the interference magnitude component and the interference phase component from a polar format to the interference signal that is represented in a Cartesian format.

17. The communication device of claim 14, wherein the interference cancellation unit is further configured to:
determine a magnitude component of the receive signal and a phase component of the receive signal;
determine an interference magnitude error based, at least in part, on the interference magnitude component and the magnitude component of the receive signal; and
determine an interference phase error based, at least in part, on the interference phase component and the phase component of the receive signal.

18. The communication device of claim 17, wherein the interference cancellation unit is further configured to:
refine magnitude coefficients of the magnitude polynomial expansion based, at least in part, on the interference magnitude error; and
refine phase coefficients of the phase polynomial expansion based, at least in part, on the interference phase error.

19. A non-transitory machine-readable storage medium having machine executable instructions stored therein, the machine executable instructions comprising instructions to:
estimate an interference magnitude component based, at least in part, on a magnitude polynomial expansion and a transmit signal of a communication device;
estimate an interference phase component based, at least in part, on a phase polynomial expansion and the transmit signal, wherein the magnitude polynomial expansion and the phase polynomial expansion have different polynomial terms;
determine an interference signal based, at least in part, on the interference magnitude component and the interference phase component; and
cancel at least a portion of the interference signal from a receive signal received by the communication device.

20. The non-transitory machine-readable storage medium of claim 19, wherein said instructions further comprise instructions to:
determine a magnitude component of the receive signal and a phase component of the receive signal;
determine an interference magnitude error based, at least in part, on the interference magnitude component and the magnitude component of the receive signal
determine an interference phase error based, at least in part, on the interference phase component and the phase component of the receive signal;
refine magnitude coefficients of the magnitude polynomial expansion based, at least in part, on the interference magnitude error; and
refine phase coefficients of the phase polynomial expansion based, at least in part, on the interference phase error.
